(19) United States
(12) Patent Application Publication
(10) Pub. No.: US 2006/0294214 A1
(43) Pub. Date: Dec. 28, 2006

(54) Event logging techniques for broadband wireless access networks

(76) Inventor: Joey Chou, Scottsdale, AZ (US)

Correspondence Address: KACVINSKY LLC;C/O INTELLEVATES, P.O. BOX 52050, MINNEAPOLIS, MN, 55402, US

(21) Appl. No.: 11/166,526

(22) Filed: Jun. 23, 2005

(51) Int. Cl. G06F 15/173

(52) U.S. Cl. 709/223

(57) ABSTRACT

An apparatus, system, method, and article for event logging for broadband wireless access networks are described. The apparatus may include a managed node to store a managed object associated with an event and to provide the managed object to a network management system. The managed object may include an event table to store an event table entry defining an event at the managed node and including an event severity attribute. The managed object may include an event log table to store an event log table entry when the event severity attribute is greater than or equal to a severity threshold. Other embodiments are described and claimed.

### BACKGROUND

Worldwide Interoperability for Microwave Access (WiMAX) is a wireless broadband technology that has the ability to compete with Digital Subscriber Line (DSL) and cable-modem technologies to provide triple play (voice, data, and video) services. To be deployed in a public broadband wireless access (BWA) network by carriers and telecom service providers, WiMAX will need to support extremely high reliability, such as five nines (99.999 per cent) reliability. Accordingly, there may be a need for techniques to facilitate the remote fault detection, monitoring, identification, and mitigation that are instrumental to achieve high reliability and lower the operation cost.

### BRIEF DESCRIPTION OF THE DRAWINGS

FIG. 1 illustrates one embodiment of a system.

FIG. 2 illustrates one embodiment of a logic flow.

FIG. 3 illustrates one embodiment of a logic flow.

FIG. 4 illustrates one embodiment of a logic flow.

### DETAILED DESCRIPTION

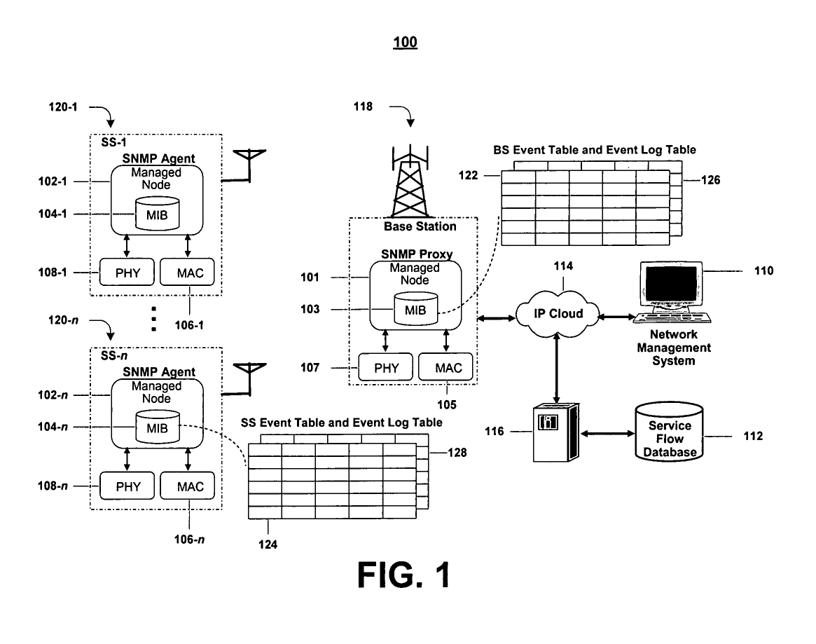

FIG. 1 illustrates one embodiment of a system. FIG. 1 illustrates a block diagram of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

The nodes of the communications system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks. The embodiments are not limited in this context.

In various implementations, the nodes of the communications system 100 may be arranged to segment a set of media information and control information into a series of packets. A packet generally may comprise a discrete data set having fixed or varying lengths, and may be represented in terms of bits or bytes. It can be appreciated that the described embodiments are applicable to any type of communication content or format, such as packets, cells, frames, fragments, units, and so forth. The embodiments are not limited in this context.

The communications system 100 may be implemented as a wired communications system, a wireless communications system, or a combination of both. For example, the communications system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The embodiments are not limited in this context.

The communications system 100 may include one or more nodes arranged to communicate information over one or more types of wireless communication media. An example of a wireless communication media may include portions of a wireless spectrum, such as the radio-frequency (RF) spectrum. In such implementations, the nodes of the system 100 may include components and interfaces suitable for communicating information signals over the designated wireless spectrum, such as one or more transmitters, receivers, transceivers, amplifiers, filters, control logic, antennas and so forth. Examples of an antenna include an internal antenna, an omni-directional antenna, a monopole antenna, a dipole antenna, an end fed antenna, a circularly polarized antenna, a micro-strip antenna, a diversity antenna, a dual antenna, an antenna array, and so forth. The embodiments are not limited in this context.

In various implementations, the communications system 100 may form part of a multi-carrier system such as a Multiple Input, Multiple Output (MIMO) system for conveying multiple data streams to multiple antennas. In such embodiments, the wireless communications media may comprise one or more multi-carrier communications channels for communicating multi-carrier communication signals. A multi-carrier channel may comprise, for example, a wideband channel comprising multiple sub-channels. The embodiments are not limited in this context.

The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), a line card, a disc controller, video controller, audio controller, and so forth. The embodiments are not limited in this context.

The communications system 100 may comprise or form part of a network, such as a broadband wireless access (BWA) network, a wireless local area network (WLAN), a wireless wide area network (WWAN), a wireless metropolitan area network (WMAN), a wireless personal area network (WPAN), a Code Division Multiple Access (CDMA) network, a Wide-band CDMA (WCDMA) network, a Time Division Synchronous CDMA (TD-SCDMA) network, a Time Division Multiple Access (TDMA) network, an Extended-TDMA (E-TDMA) network, a Global System for Mobile Communications (GSM) network, an Orthogonal Frequency Division Multiplexing (OFDM) network, an Orthogonal Frequency Division Multiple Access (OFDMA) network, a North American Digital Cellular (NADC) network, a Universal Mobile Telephone System (UMTS) network, a third generation (3G) network, a fourth generation (4G) network, a local area network (LAN), a wide area network (WAN), a metropolitan area network (MAN), the Internet, the World Wide Web, a cellular network, a radio network, a satellite network, and/or any other communications network configured to carry data. The embodiments are not limited in this context.

The communications system 100 may communicate information in accordance with one or more standards, such as standards promulgated by the Institute of Electrical and Electronics Engineers (IEEE), the Internet Engineering Task Force (IETF), the International Telecommunications Union (ITU), and so forth. In various embodiments, for example, the communications system 100 may communicate information according to one or more IEEE 802 standards including IEEE 802.11 standards (e.g., 802.11 a, b, g/h, j, n, and variants) for WLANs and/or 802.16 standards (e.g., 802.16-2004, 802.16.2-2004, 802.16e, 802.16f, and variants) for WMANs. The communications system 100 may communicate information according to one or more of the Digital Video Broadcasting Terrestrial (DVB-T) broadcasting standard and the High performance radio Local Area Network (HiperLAN) standard. The embodiments are not limited in this context.

The communications system 100 may communicate information in accordance with one or more protocols, such as protocols defined by one or more IEEE 802 standards, or other standard bodies, for example. In various embodiments, the system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth. The embodiments are not limited in this context.

As shown in FIG. 1, for example, the communications system 100 may comprise or be implemented as a BWA network such as a Mobile BWA network. In various implementations, the BWA network may be arranged to operate according to one or more IEEE 802.16 standards. The IEEE 802.16 standards may define, for example, air interface specifications (e.g. WMAN, WirelessHUMAN) for providing broadband wireless services (e.g., triple play services) to MANs. In various embodiments, the BWA network may operate according to the 802.16f Draft Amendment to IEEE Standard for Local and Metropolitan Area Networks—Part 16: Air Interface for Fixed Broadband Wireless Access Systems—Management Information Base (2005). The embodiments are not limited in this context.

The BWA network may comprise one or more managed nodes such as managed nodes 101 and 102-1-n, where n represents any positive integer. The managed nodes 101 and 102-1-n may comprise Management Information Bases (MIBs), such as MIBs 103 and 104-1-n, for example. In various embodiments, the MIBs 103 and 104-1-n may be arranged to store and provide access to data. Each of the MIBs 103 and 104-1-n may comprise any type of data structure (e.g., array, file, table, record) and may be implemented by various types of storage media. Examples of storage media include read-only memory (ROM), random-access memory (RAM), static RAM (SRAM), dynamic RAM (DRAM), Double-Data-Rate DRAM (DDRAM), synchronous DRAM (SDRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic disk (e.g., floppy disk and hard drive), optical disk (e.g., CD-ROM), magnetic or optical cards, or any other type of media suitable for storing information. The embodiments are not limited in this context.

In various embodiments, the managed nodes 101 and 102-1-n may communicate with MAC layers 105 and 106-1-n and Physical (PHY) layers 107 and 108-1-n. The MAC layers 105 and 106-1-n may be arranged to provide a medium-independent interface to the Physical (PHY) layers 107 and 108-1-n. In various implementations, the MAC layers 105 and 106-1-n may be arranged to manage uplink and downlink resources and to support Quality of Service (QoS) for multimedia traffic. The MAC layers 105 and 106-1-n may perform functions such as link adaptation and Automatic Repeat Request (ARQ), for example, to maintain acceptable Bit Error Rates (BER). The PHY layers 107 and 108-1-n may comprise, for example wireless layers such Orthogonal Frequency Division Multiplexing (OFDM) layers and/or an Orthogonal Frequency Division Multiple Access (OFDMA) layers. The embodiments are not limited in this context.

The BWA network may comprise a Network Management System (NMS) 110. In various implementations, the NMS 110 may act in a network manager role for the managed nodes, such as managed nodes 101 and 102-1-n. The BWA network also may comprise a service flow database 112. In various embodiments the service flow database 112 may be arranged to contain the service flow and the associated QoS information to be populated to the managed nodes. The service flow database 112 may be accessible through a network 114 such as an IP network and/or one or more servers, such as server 116 for example. The embodiments are not limited in this context

In various embodiments, the managed node 101 may be implemented as a base station (BS) 118 such as a WiMAX base station. The managed nodes 102-1-n may be implemented as subscriber stations (SS-n) 120-n such as WiMAX subscriber stations, for example. The embodiments are not limited in this context.

In various embodiments, one or more of the subscriber stations 120-n may comprise or be implemented as an agent such as an SNMP agent, for example. The base station 118 may comprise or be implemented as an agent and/or as a proxy such as an SNMP proxy acting on behalf of managed subscriber stations 120-n. In various implementations, agents of subscriber stations 120-n may be managed directly by the NMS 110 and/or may be managed indirectly through a proxy of the BS 118. The embodiments are not limited in this context.

In various implementations, upon entering the BWA network the subscriber stations 120-n may be arranged to create one or more connections over which data may be transmitted to and from the base station 118. The service flow database 112 may contain the service flow and the associated QoS information to be populated to the base station 118 and to the subscriber stations 120-n when a subscriber station enters the BWA network and/or when service is provisioned, for example. In various embodiments, service flow attributes can be shared by multiple service flows and can be added or deleted dynamically to meet different QoS demands from subscribers. The embodiments are not limited in this context.

In various embodiments, the managed nodes 101 and 102-1-n may be arranged to collect and store managed objects. The managed objects may be stored in MIBs, such as MIBs 103 and 104-1-n, for example. In various implementations, the managed objects may be made available to the NMS 110 using SNMP. The embodiments are not limited in this context.

In various implementations, the managed objects may be defined according to a MIB format, such as a Wireless MAN Interface MIB (wmanIfMib) format. The MIB format may comprise, for example, an 802.16 standard format that is SNMP (e.g., SNMPv1, SNMPv2, SNMPv3) compliant and/or compatible. The MIB format may support the management of MAC and PHY layer features to provide management interoperability and remote capability needed for WiMAX deployment by carriers. The embodiments are not limited in this context.

In various embodiments, the MIB format may define managed objects for reporting the status and/or occurrence of events such as software and hardware events. The managed objects may comprise BS and/or SS managed objects implemented by the SNMP agent of a BS and/or a SS, for example. The managed objects may comprise notifications reported through mechanisms, such as traps and non-volatile logging. The managed objects may be reported to the NMS 110, which may respond by issuing an alarm with a certain severity depending on the status and the reason received. In various implementations, the definition and coding of events may be vendor-specific. To assist network operators to troubleshoot multi-vendor equipment, event and trap definitions may comprise human-readable text. The embodiments are not limited in this context.

In various embodiments, the managed objects may comprise notifications based on the occurrence and/or status of fault events and exceptions. Examples of notifications may include, for example, a dynamic service notification to report the failure of a dynamic service operation during the dynamic services process, a received signal strength indicator (RSSI) change notification to report that the uplink RSSI is above or below a threshold, a Baseline Privacy Key Management (BPKM) notification to report the failure of a BPKM operation, a register notification to report that a SS has registered and/or de-registered at a BS, a power status change notification to report a change in the status and/or failure of a power supply, a fan status notification to report the status of a fan, and a temperature change notification to report when the temperature is above or below a threshold. The embodiments are not limited in this context.

In various implementations, the managed objects may be used for event logging to provide a standard and centralized way to record important software and hardware events. The managed objects may comprise an Event Log data structure associated with one or more events. The Event Log data structure may record transient information against the possibility that a notification message can be lost. The Event Log data structure may enhance fault mitigation, system debugging, and the monitoring of the system operation and performance. The embodiments are not limited in this context.

In various embodiments, the Event Log data structure may comprise an Event Log configuration such as a BS Event Log configuration and/or an SS Event Log configuration, for example. The Event Log configuration may comprise an Entry Limit attribute defining the maximum number of event entries that may be held in an Event Log table. In various implementations, if an application changes the limit while there are events in the log, the oldest events may be discarded to bring the log down to the new limit. The embodiments are not limited in this context.

The Event Log configuration may comprise an Event Life Time Limit attribute defining a time limit (e.g., number of minutes) that an event should be kept in the log before it is automatically removed. In various implementations, if an application changes the value of the time limit, events that are older than the new time may be discarded to meet the new time limit. The embodiments are not limited in this context.

The Event Log configuration may comprise an Event Log Severity Threshold attribute defining the minimum severity level of the event that will be logged into a buffer. The Event Log configuration may comprise an Event Log Wrap Around Buffer Enable attribute enabling the wrap around of a log buffer when the buffer is full. The Event log configuration may comprise an Event Log Latest Event attribute including an index pointing to the latest event in an Event Log Table. The embodiments are not limited in this context.

In various embodiments, the Event Log data structure may comprise an Event Table such as a BS Event Table and/or an SS Event Table, for example. In various implementations, the Event Table may comprise one or more event entries defining one or more events that can be generated by a BS or an SS. In various implementations, the event entries may be indexed by an interface index (ifIndex) and/or an Event Id. The embodiments are not limited in this context.

As illustrated in FIG. 1, the managed node 101 implemented by the base station (BS) 118 may store a BS Event Table 122 in the MIB 103. The managed node 102-n implemented by the subscriber station (SS-n) 120-n may store an SS Event Table 124 stored in the MIB 104-n. In various implementations, the BS Event Table 122 and the SS Event Table 124 may be accessed by the NMS 110 using SNMP, for example. The embodiments are not limited in this context.

Table 1, shown below, illustrates one example of an Event Table.

TABLE 1

| | Event Description | Event | Event | |
|---|---|---|---|---|
| Event ID | String | Severity | Notification | Event Notification OID |
| rcvBcRangOpp | Received broadcast | Notice | No | NA |
| | ranging opportunity | | | |
| ssRssiChange | RSSI change across | Critical | Yes | wmanSsRssiStatusChangeTrap |
| | high/low threshold | | | |

The Event Table may comprise an Event Identifier (Event ID) attribute. In various embodiments, the Event ID attribute may comprise a coded and/or numeric value representing an event. In various implementations, the Event ID attribute may be configurable from the NMS 110. The embodiments are not limited in this context.

The Event Table may comprise an Event Description attribute. In various embodiments, the Event Description attribute may comprise a string description of the event. In various implementations, the Event Description attribute may be configurable from the NMS 110. The embodiments are not limited in this context.

The Event Table may comprise an Event Severity attribute describing the severity of an event. In various embodiments, the system 100 may assign a severity for each event. For example, the Event Severity attribute may be configurable from the NMS 100. The embodiments are not limited in this context.

The Event Severity attribute may comprise emergency events. In various embodiments, emergency events may comprise vendor-specific fatal hardware and/or software errors that prevent normal system operation and cause a reporting system to reboot. In various implementations, vendors may define their own set of emergency events. The embodiments are not limited in this context.

The Event Severity attribute may comprise an alert event. In various embodiments, alert events may comprise serious failures that cause a reporting system to reboot but that are not caused by hardware and/or software malfunctions. In various implementations, a cold/warm start notification may be sent after recovering from a critical event. In cases where the alert event can not be reported as a Trap or SYSLOG message, it may be stored in an internal log file. The code of an alert event can be saved in non-volatile memory and reported later. The embodiments are not limited in this context.

The Event Severity attribute may comprise a critical event. In various embodiments, critical events may comprise serious failures that require attention and prevent a device from transmitting data but that may be recovered without rebooting the system. In various implementations, a Link Up notification may be sent after recovering from the error. In cases where the critical event can not be reported as a Trap or SYSLOG message, it may be stored in the internal log file. The code of a critical event can be reported later. The embodiments are not limited in this context.

The Event Severity attribute may comprise an error event. In various embodiments, error events may comprise failures that could interrupt the normal data flow but will not cause a SS to re-register. In various implementations, error events can be reported in real time by using a trap or SYSLOG mechanism. The embodiments are not limited in this context.

The Event Severity attribute may comprise a warning event. In various embodiments, warning events may comprise failures that could interrupt the normal data flow but will not cause a SS to re-register. In various implementations, a warning level may be assigned to events that both SS and BS have information about. To prevent sending the same event both from the SS and the BS, the trap and Syslog reporting mechanism may be disabled by default for warning events. The embodiments are not limited in this context.

The Event Severity attribute may comprise a notice event. In various embodiments, notice events may comprise important events that are not failures. In various implementations, notice events can be reported in real time by using the trap or SYSLOG mechanism. The embodiments are not limited in this context.

The Event Severity attribute may comprise an informational event. In various embodiments, informational events may comprise events of marginal importance that are not failures, but may be helpful for tracing the normal modem operation. The embodiments are not limited in this context.

The Event Severity attribute may comprise a debug event. In various embodiments, debug events may be reserved for vendor-specific non-critical events. The embodiments are not limited in this context.

The Event Table may comprise an Event Notification attribute. In various embodiments, the Event Notification attribute may comprise a Boolean value indicating whether a particular event should be reported immediately to the NMS 100 through an SNMP trap, for example. In various implementations, the Event Notification attribute may be configurable from the NMS 110. In some cases, the NMS 110 can disable the event report, if it is determined that the event has flooded the system. The embodiments are not limited in this context.

The Event Table may comprise an Event Notification Object Identifier (OID) attribute. In various embodiments, the Event Notification OID may comprise the object identifier of a notification-type object. In various implementations, if the Event Notification attribute is true, a trap identified by the OID will be reported. The embodiments are not limited in this context.

In various embodiments, the Event Log data structure may comprise an Event Log Table such as a BS Event Log Table and/or an SS Event Log Table, for example. The Event Log Table may comprise a table (e.g., SYSLOG table) to store local events that have occurred at a BS or an SS. The Event Log Table may reside in non-volatile memory and should persist after power cycle and/or reboot. In various implementations, the number of entries in the Event Log table may be determined by an Event Log Entry Limit attribute that defines a log buffer size. The Event Log Table may comprise a wrap around buffer in which entries appear when events occur and are removed to make room for new entries when the log buffer is full and/or when the entry passes a life time limit. The embodiments are not limited in this context.

In various embodiments, the Event Log Table may index event entries by ifIndex and/or an Event Log Index attribute. The Event Log Index attribute may comprise a monotonically increasing integer for the purpose of indexing entries within the Event Table Log. In various implementations, when the Event Log Index attribute reaches a maximum value, an agent may wrap the value back to 1. The embodiments are not limited in this context.

As illustrated in FIG. 1, the managed node 101 implemented by the base station (BS) 118 may store a BS Event Log Table 126 in the MIB 103. The managed node 102-n implemented by the subscriber station (SS-n) 120-n may store an SS Event Log Table 128 stored in the MIB 104-n. In various embodiments, the BS Event Log Table 126 and the SS Event Log Table 128 may be provided to the NMS 110 using SNMP, for example. The embodiments are not limited in this context.

Table 2, shown below, illustrates one example of an Event Log Table.

TABLE 2

| | Event Logged | Event Log | Event |
|---|---|---|---|
| Event ID | Time | Description | Severity |
| rcvBcRangOpp | 2004-11- | Received broadcast | Notice |
| | 11T13:20:50.52Z | ranging opportunity | |
| ssRssiChange | 2004-11- | RSSI change across | Critical |
| | 11T13:20:50.52Z | high/ow threshold | |

The Event Log Table may comprise an Event Identifier (Event ID) attribute. In various embodiments, the Event ID attribute may comprise a coded and/or numeric value representing an event. In various implementations, the Event ID attribute may be configurable from the NMS 110. The embodiments are not limited in this context.

The Event Log Table may comprise an Event Logged Time attribute. In various embodiments, the Event Logged Time attribute may comprise a time value (e.g., sysUpTime) when the entry was placed in the Event Table Log. In various implementations, if the entry occurred before the most recent management system initialization, the value is set to zero. The embodiments are not limited in this context.

The Event Table Log may comprise an Event Description attribute. In various embodiments, the Event Description attribute may comprise a string description of the event. In various implementations, the Event Description attribute may be configurable from the NMS 110. The embodiments are not limited in this context.

The Event Table may comprise an Event Severity attribute describing the severity of an event. In various embodiments, the system 100 may assign a severity for each event. For example, the Event Severity attribute may be configurable from the NMS 100. The embodiments are not limited in this context.

The Event Severity attribute may comprise, for example: an emergency event, an alert event, a critical event, an error event, a warning event, a notice event, an informational event, and/or a debug event. The embodiments are not limited in this context.

Operations for various embodiments may be further described with reference to the following figures and accompanying examples. Some of the figures may include a logic flow. It can be appreciated that an illustrated logic flow merely provides one example of how the described functionality may be implemented. Further, a given logic flow does not necessarily have to be executed in the order presented unless otherwise indicated. In addition, a logic flow may be implemented by a hardware element, a software element executed by a processor, or any combination thereof. The embodiments are not limited in this context.

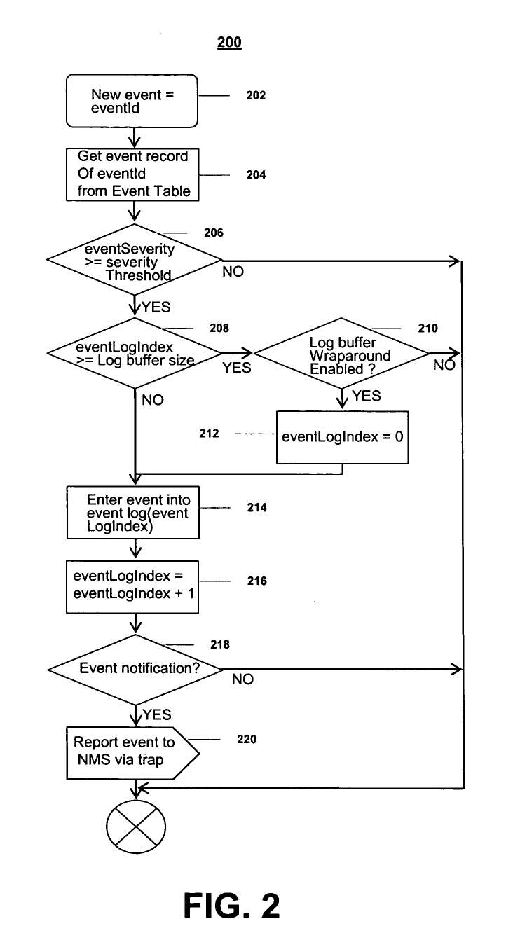

FIG. 2 illustrates one embodiment of a logic flow. FIG. 2 illustrates a logic flow 200 for an Event Log operation. In various embodiments, the logic flow 200 may be performed by a communications system (e.g. communications system 100) and/or a node (e.g., managed nodes 101 and 102-1-n). It is to be understood that the logic flow 200 may be implemented by various other types of hardware, software, and/or combination thereof. The embodiments are not limited in this context.

The logic flow 200 may comprise generating a new event (block 202). In various embodiments, the new event may comprise an Event ID attribute. When a new event is generated, the Event ID attribute may be used to get an event record (block 204). The event record may comprise various attributes (e.g., Event ID, Event Description, Event Severity, Event Notification, Event Notification OID) associated with the event. In various implementations, an Event Table may be searched based on the Event ID attribute to get the event record. The embodiments are not limited in this context.

In various embodiments, if the Event Severity attribute is lower than a severity threshold (block 206), the event will be ignored. In various implementations, the severity threshold may be set by a NMS such as NMS 110, for example. The embodiments are not limited in this context.

In various embodiments, if the Event Log Index attribute is greater than or equal to a log buffer size (block 208), a check is made to determined whether a buffer wrap-around feature is enabled (block 210). In various implementations, an Event Log Wrap Around Buffer Enable attribute is checked when the Event Log Index reaches the end of the buffer. If the buffer wrap-around feature is not enabled, the event will be ignored; otherwise, the Event Log Index attribute is reset to the beginning of the buffer (block 212). The embodiments are not limited in this context.

In various embodiments, an event entry is entered into an Event Log Table (block 214). The event entry may be indexed in the buffer by the Event Log Index attribute, for example. In various implementations, the event entry may comprise an Event ID attribute, an Event Logged Time attribute (e.g., time stamp), an Event Description attribute, and an Event Severity attribute (e.g., emergency, alert, critical, error, warning, notice, informational, and/or debug). The embodiments are not limited in this context.

In various embodiments, the Event Log Index is incremented (block 216). In various implementations, if the Event Notification attribute in the event record is YES (block 218), the event is reported (block 220). The event may be reported immediately to the NMS 110 by a trap (e.g., NMS trap). The embodiments are not limited in this context.

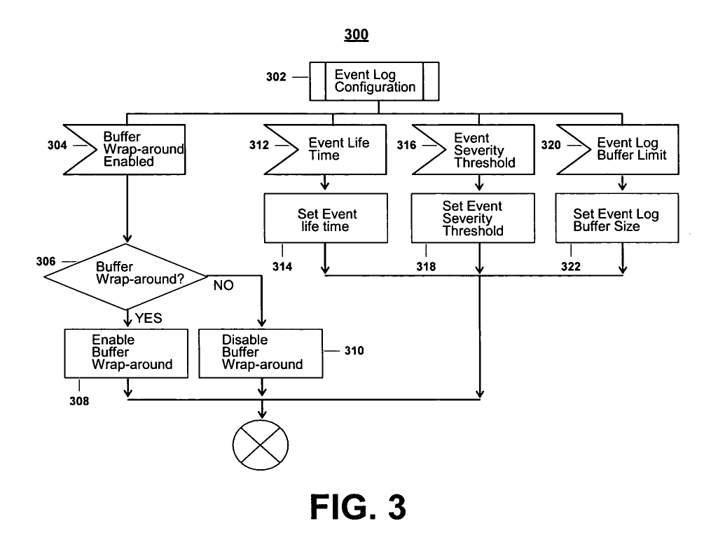

FIG. 3 illustrates one embodiment of a logic flow. FIG. 3 illustrates a logic flow 300 for an Event Log configuration operation. In various embodiments, the logic flow 300 may be performed by a communications system (e.g. communications system 100) and/or a node (e.g., managed nodes 101 and 102-1-n). It is to be understood that the logic flow 300 may be implemented by various other types of hardware, software, and/or combination thereof. The embodiments are not limited in this context.

In various embodiments, the logic flow 300 may comprise an Event Log configuration (block 302) for a Buffer Wrap Around Enable attribute (block 304). The Buffer Wrap Around Enable attribute may indicate if the log buffer should wrap around when the log reaches the end of the buffer. In various implementations, if it is determined that the buffer wrap-around feature should be enabled (block 306), the buffer wrap-around feature is enabled (block 308). Otherwise, the buffer wrap-around feature is disabled (block 310). The embodiments are not limited in this context.

In various embodiments, an Event Time Life attribute may be configured (block 312) by setting an event life time (block 314). The Event Life Time attribute may indicate the life time of an event. In various implementations, when an event passes the event life time, it will be removed from the log. The embodiments are not limited in this context.

In various embodiments, an Event Severity Threshold attribute may be configured (block 316) by setting an event severity threshold (block 318). In various implementations, an event will be logged only if the event severity is equal or above the event severity threshold. In some cases, the NMS 100 may raise the threshold to prevent an event with lower severity from flooding the system. The embodiments are not limited in this context.

In various embodiments, an Event Log Buffer Limit attribute may be configured (block 320) by setting the event log buffer size (block 322). In various implementations, the size of the event log buffer may be specified by an entry limit. The embodiments are not limited in this context.

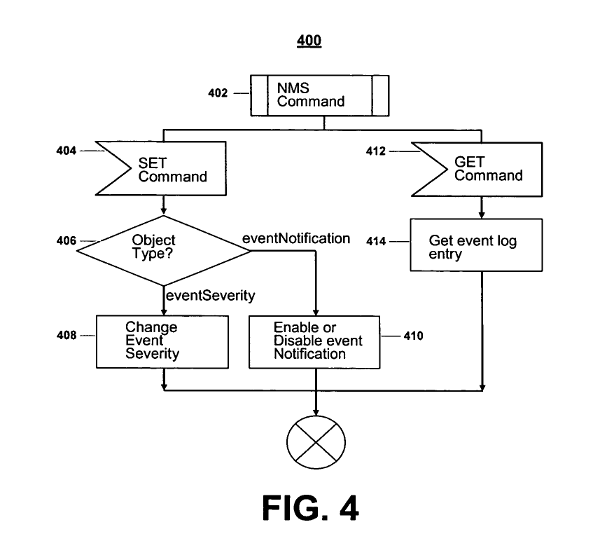

FIG. 4 illustrates one embodiment of a logic flow. FIG. 4 illustrates a logic flow 400 for NMS command processing. In various embodiments, the logic flow 400 may be performed by a system (e.g. communications system 100, NMS 110). It is to be understood that the logic flow 400 may be implemented by various other types of hardware, software, and/or combination thereof. The embodiments are not limited in this context.

In various embodiments, the logic flow 400 may comprise processing a NMS Command (block 402). The logic flow 400 may comprise a SET command (block 404). In various implementations, the attributes of an entry may be set in an Event Table based on object type (block 406). For example, the severity (e.g., emergency, alert, critical, error, warning, notice, informational, and/or debug) of each event in the Event Table may be changed and/or configured (block 408), and the event notification of each event in the Event Table may be enabled or disabled (block 410). The embodiments are not limited in this context.

The logic flow 400 may comprise a GET command (block 412) to get an event log entry (block 414). In various embodiments, each event in an event log may be accessed by the NMS 110. In various implementations, an Event Log Latest Event attribute may comprise a global parameter to indicate the latest event in the log. The Event Log Latest Event attribute may be provided to the NMS 100 to allow access to the latest event in the log buffer. The embodiments are not limited in this context.

One embodiment of an Event Log comprising Abstract Syntax Notation number One (ASN. 1) text is described in Appendix A. The embodiments, however, are not limited in this context.

In various implementations, the described embodiments may comprise software architecture for an event logging mechanism, which is instrumental to fault mitigation, system debugging, and the monitoring of system operation and performance statistics that play an important role to achieve five nines (99.999 percent) reliability required by BWA service providers. The architecture may provide remote fault identification and mitigation features that can minimize truck toll. The event logging mechanism may be adopted into various IEEE 802.16 standards, such as the 802.16f standard. The embodiments are not limited in this context.

The described embodiments may be implemented by various WiMAX compliance products to improve system reliability and reduce operation cost (minimize truck roll). The described embodiments may provide a flexible way to configure the severity of each event and event threshold to prevent event flooding. The described embodiments may support real-time event reporting through traps to report critical fault. The described embodiments may provide a standard way to record and report important software and hardware events as well as a standard way for NMS to retrieve events. The architecture may be used in WiMAX test MIB to assist WiMAX certification tests. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the communications system 100 may be illustrated using a particular communications media by way of example, it may be appreciated that the principles and techniques discussed herein may be implemented using any type of communication media and accompanying technology. For example, the communications system 100 may be implemented as a wired communication system, a wireless communication system, or a combination of both. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an ASIC, PLD, DSP, and so forth. In yet another example, an embodiment may be implemented by any combination of programmed general-purpose computer components and custom hardware components. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

APPENDIX A
WmanIfEventSeverity ::= TEXTUAL-CONVENTION

| | |
|---|---|
| STATUS | current |
| DESCRIPTION | |

```
          “WmanIfEventSeverity defines the alarm Severity of an
            event.”
      SYNTAX  INTEGER {emergency(1),
                  alert(2),
                  critical(3),
                  error(4),
                  warning(5),
                  notice(6)
                  informational(7),
                  debug(8)}
--
-- BS Event log configuration
--
wmanIfBsEventLogEntryLimit OBJECT-TYPE
```

| | |
|---|---|
| SYNTAX | INTEGER |
| MAX-ACCESS | read-write |
| STATUS | current |
| DESCRIPTION | |

```
          “The maximum number of event entries that may be held
            in wmanIfBsEventLogTable. If an application changes
            the limit while there are events in the log, the
            oldest events must be discarded to bring the log down
            to the new limit.”
      DEFVAL  { 200 }
      ::= { wmanIfBsEventLog 1 }
wmanIfBsEventLifeTimeLimit OBJECT-TYPE
```

| | |
|---|---|
| SYNTAX | INTEGER |
| UNITS | “minutes” |
| MAX-ACCESS | read-write |
| STATUS | current |
| DESCRIPTION | |

```
          “The number of minutes an event should be kept in the log
            before it is automatically removed. If an application
            changes the value of wmanIfBsEventLifeTimeLimit, events
            that are older than the new time may be discarded to meet
            the new lifetime. A value of 0 means lifetime limit.”
      DEFVAL  { 1440 }
      ::= { wmanIfBsEventLog 2 }
wmanIfBsEventLogSeverityThreshold OBJECT-TYPE
```

| | |
|---|---|
| SYNTAX | WmanIfEventSeverity |
| MAX-ACCESS | read-write |
| STATUS | current |
| DESCRIPTION | |

```
          “This object defines the minimum severity level of the
            event that will be logged into the buffer.”
      DEFVAL  { warning }
      ::= { wmanIfBsEventLog 3 }
wmanIfBsEventLogWrapAroundBuffEnable OBJECT-TYPE
```

| | |
|---|---|
| SYNTAX | TruthValue |
| MAX-ACCESS | read-write |
| STATUS | current |
| DESCRIPTION | |

```
          “True (1), indicates that the log buffer will be wrapped
            around when the buffer is full.”
      DEFVAL  { 1 }
      ::= { wmanIfBsEventLog 4 }
wmanIfBsEventLogLatestEvent OBJECT-TYPE
```

| | |
|---|---|
| SYNTAX | Unsigned32 (1..4294967295) |
| MAX-ACCESS | not-accessible |
| STATUS | current |
| DESCRIPTION | |

```
          “This object is the index pointing to the latest event in
            wmanIfBsEventLogTable”
      DEFVAL  { 1 }
      ::= { wmanIfBsEventLog 5 }
wmanIfBsEventTable OBJECT-TYPE
```

| | |
|---|---|
| SYNTAX | SEQUENCE OF WmanIfBsEventEntry |
| MAX-ACCESS | not-accessible |
| STATUS | current |
| DESCRIPTION | |

```
          “This table provides the events that are supported by BS.”
      ::= { wmanIfBsEventLog 6 }
wmanIfBsEventEntry OBJECT-TYPE
```

| | |
|---|---|
| SYNTAX | WmanIfBsEventEntry |
| MAX-ACCESS | not-accessible |
| STATUS | current |
| DESCRIPTION | |

```
          “Each entry in this table represents an event that can be
            generated by BS. It is indexed by ifIndex and
            wmanIfBsEventId.”
      INDEX  { ifIndex, wmanIfBsEventIdentifier }
      ::= { wmanIfBsEventTable 1 }
WmanIfBsEventEntry ::= SEQUENCE {
```

| | |
|---|---|
| wmanIfBsEventIdentifier | INTEGER, |
| wmanIfBsEventDescription | SnmpAdminString, |
| wmanIfBsEventSeverity | WmanIfEventSeverity, |
| wmanIfBsEventNotification | TruthValue, |
| wmanIfBsEventNotificationOid | OBJECT IDENTIFIER} |

wmanIfBsEventIdentifier OBJECT-TYPE

| | |
|---|---|
| SYNTAX | INTEGER (1..100000) |
| MAX-ACCESS | not-accessible |
| STATUS | current |
| DESCRIPTION | |

```
          “A numeric value represents the Event Identifier.”
      ::= { wmanIfBsEventEntry 1 }
wmanIfBsEventDescription OBJECT-TYPE
```

| | |
|---|---|
| SYNTAX | SnmpAdminString |
| MAX-ACCESS | read-write |
| STATUS | current |
| DESCRIPTION | |

```
          “This object describes the event.”
      ::= { wmanIfBsEventEntry 2 }
wmanIfBsEventSeverity OBJECT-TYPE
```

| | |
|---|---|
| SYNTAX | WmanIfEventSeverity |
| MAX-ACCESS | read-write |
| STATUS | current |
| DESCRIPTION | |

```
          “This object describes the severity of such event.
            The system will assign a severity for each event. But,
            it can be configurable by NMS”
      ::= { wmanIfBsEventEntry 3 }
wmanIfBsEventNotification OBJECT-TYPE
```

| | |
|---|---|
| SYNTAX | TruthValue |
| MAX-ACCESS | read-write |
| STATUS | current |
| DESCRIPTION | |

```
          “An event notification will be reported when it is
            True (1).”
      DEFVAL  { 2 }
      ::= { wmanIfBsEventEntry 4 }
wmanIfBsEventNotificationOid OBJECT-TYPE
```

| | |
|---|---|
| SYNTAX | OBJECT IDENTIFIER |
| MAX-ACCESS | read-only |
| STATUS | current |
| DESCRIPTION | |

```
          “This is the object identifier of a NOTIFICATION-TYPE
            object. If wmanIfBsEventNotification is True, a trap that
            is identified by this OID will be reported.”
      DEFVAL  { wmanBsEventTrap }
      ::= { wmanIfBsEventEntry 5 }
wmanIfBsEventLogTable OBJECT-TYPE
```

| | |
|---|---|
| SYNTAX | SEQUENCE OF WmanIfBsEventLogEntry |
| MAX-ACCESS | not-accessible |
| STATUS | current |
| DESCRIPTION | |

```
          “This is the Syslog table that is used to store Bs local
            events. This table should reside in the non-volatile
            memory that should presist after power cycle or reboot.
            The number of entries in this table is determined by
            wmanIfBsEventLogEntryLimit. It is a wrap around buffer.
            When the buffer is full, the oldest entry will be removed
            to make room for the newest entry.”
      ::= { wmanIfBsEventLog 7 }
wmanIfBsEventLogEntry OBJECT-TYPE
```

| | |
|---|---|
| SYNTAX | WmanIfBsEventLogEntry |
| MAX-ACCESS | not-accessible |
| STATUS | current |
| DESCRIPTION | |

```
          “Entries appear in this table when events occur, and are
            removed to make ways for new entries when buffer is full,
            the entry passes the lifetime limit. This table is
            indexed by ifIndex and wmanIfBsEventLogIndex.”
      INDEX  { ifIndex, wmanIfBsEventLogIndex }
      ::= { wmanIfBsEventLogTable 1 }
WmanIfBsEventLogEntry ::= SEQUENCE {
```

| | |
|---|---|
| wmanIfBsEventLogIndex | Unsigned32, |
| wmanIfBsEventId | INTEGER, |
| wmanIfBsEventLoggedTime | TimeStamp, |
| wmanIfBsEventLogDescription | SnmpAdminString, |
| wmanIfBsEventLogSeverity | WmanIfEventSeverity} |

wmanIfBsEventLogIndex OBJECT-TYPE

| | |
|---|---|
| SYNTAX | Unsigned32 (1..4294967295) |
| MAX-ACCESS | read-only |
| STATUS | current |
| DESCRIPTION | |

```
          “A monotonically increasing integer for the sole purpose
            of indexing entries within the event log. When it
            reaches the maximum value, the agent wraps the value
            back to 1.”
      ::= { wmanIfBsEventLogEntry 1 }
wmanIfBsEventId OBJECT-TYPE
```

| | |
|---|---|
| SYNTAX | INTEGER |
| MAX-ACCESS | read-only |
| STATUS | current |
| DESCRIPTION | |

```
          “The identifier of a BS event.”
      ::= { wmanIfBsEventLogEntry 2 }
wmanIfBsEventLoggedTime OBJECT-TYPE
```

| | |
|---|---|
| SYNTAX | TimeStamp |
| MAX-ACCESS | read-only |
| STATUS | current |
| DESCRIPTION | |

```
          “The value of sysUpTime when the entry was placed in the
            log. If the entry occurred before the most recent
            management system initialization this object value must
            be set to zero.”
      ::= { wmanIfBsEventLogEntry 3 }
wmanIfBsEventLogDescription OBJECT-TYPE
```

| | |
|---|---|
| SYNTAX | SnmpAdminString |
| MAX-ACCESS | read-only |
| STATUS | current |
| DESCRIPTION | |

```
          “This object describes the event.”
      ::= { wmanIfBsEventLogEntry 4 }
wmanIfBsEventLogSeverity OBJECT-TYPE
```

| | |
|---|---|
| SYNTAX | WmanIfEventSeverity |
| MAX-ACCESS | read-only |
| STATUS | current |
| DESCRIPTION | |

```
          “This object describes the severity of such event.”
      ::= { wmanIfBsEventLogEntry 5 }
wmanBsEventTrap NOTIFICATION-TYPE
```

| | |
|---|---|
| OBJECTS | {wmanIfBsEventId, |
| | wmanIfBsEventLogIndex, |
| | wmanIfBsEventLoggedTime, |
| | wmanIfBsEventDescription, |
| | wmanIfBsEventSeverity} |

| | |
|---|---|
| STATUS | current |
| DESCRIPTION | |

```
          “This trap report the event.”
      ::= { wmanIfBsTrapDefinitions 12 }
--
-- SS Event log configuration
--
wmanIfSsEventLogEntryLimit  OBJECT-TYPE
```

| | |
|---|---|
| SYNTAX | INTEGER |
| MAX-ACCESS | read-write |
| STATUS | current |
| DESCRIPTION | |

```
          “The maximum number of event entries that may be held
            in wmanIfSsEventLogTable. If an application changes
            the limit while there are events in the log, the
            oldest events must be discarded to bring the log down
            to the new limit.”
      DEFVAL  { 100 }
      ::= { wmanIfSsEventLog 1 }
wmanIfSsEventLifeTimeLimit  OBJECT-TYPE
```

| | |
|---|---|
| SYNTAX | INTEGER |
| UNITS | “minutes” |
| MAX-ACCESS | read-write |
| STATUS | current |
| DESCRIPTION | |

```
          “The number of minutes an event should be kept in the log
            before it is automatically removed. If an application
            changes the value of wmanIfSsEventLifeTimeLimit, events
            that are older than the new time may be discarded to meet
            the new lifetime. A value of 0 means lifetime limit.”
      DEFVAL  { 1440 }
      ::= { wmanIfSsEventLog 2 }
wmanIfSsEventLogSeverityThreshold  OBJECT-TYPE
```

| | |
|---|---|
| SYNTAX | WmanIfEventSeverity |
| MAX-ACCESS | read-write |
| STATUS | current |
| DESCRIPTION | |

```
          “This object defines the minimum severity level of the
            event that will be logged into the buffer.”
      DEFVAL  { warning }
      ::= { wmanIfSsEventLog 3 }
wmanIfSsEventLogWrapAroundBuffEnable  OBJECT-TYPE
```

| | |
|---|---|
| SYNTAX | TruthValue |
| MAX-ACCESS | read-write |
| STATUS | current |
| DESCRIPTION | |

```
          “True (1), indicates that the log buffer will be wrapped
            around when the buffer is full.”
      DEFVAL { 1 }
      ::= { wmanIfSsEventLog 4 }
wmanIfSsEventLogLatestEvent OBJECT-TYPE
```

| | |
|---|---|
| SYNTAX | Unsigned32 (1..4294967295) |
| MAX-ACCESS | not-accessible |
| STATUS | current |
| DESCRIPTION | |

```
          “This object is the index pointing to the latest event in
            wmanIfSsEventLogTable”
      DEFVAL { 1 }
      ::= { wmanIfSsEventLog 5 }
wmanIfSsEventTable OBJECT-TYPE
```

| | |
|---|---|
| SYNTAX | SEQUENCE OF WmanIfSsEventEntry |
| MAX-ACCESS | not-accessible |
| STATUS | current |
| DESCRIPTION | |

```
          “This table provides the events that are supported by SS.”
      ::= { wmanIfSsEventLog 6 }
wmanIfSsEventEntry OBJECT-TYPE
```

| | |
|---|---|
| SYNTAX | WmanIfSsEventEntry |
| MAX-ACCESS | not-accessible |
| STATUS | current |
| DESCRIPTION | |

```
          “Each entry in this table represents an event that can be
            generated by SS. It is indexed by wmanIfSsEventId.”
      INDEX  { ifIndex, wmanIfSsEventIdentifier }
      ::= { wmanIfSsEventTable 1 }
WmanIfSsEventEntry ::= SEQUENCE {
```

| | |
|---|---|
| wmanIfSsEventIdentifier | INTEGER, |
| wmanIfSsEventDescription | SnmpAdminString, |
| wmanIfSsEventSeverity | WmanIfEventSeverity, |
| wmanIfSsEventNotification | TruthValue, |
| wmanIfSsEventNotificationOid | OBJECT IDENTIFIER} |

wmanIfSsEventIdentifier OBJECT-TYPE

| | |
|---|---|
| SYNTAX | INTEGER (1..100000) |
| MAX-ACCESS | not-accessible |
| STATUS | current |
| DESCRIPTION | |

```
          “A numeric value represents the Event Identifier.”
      ::= { wmanIfSsEventEntry 1 }
wmanIfSsEventDescription OBJECT-TYPE
```

| | |
|---|---|
| SYNTAX | SnmpAdminString |
| MAX-ACCESS | read-write |
| STATUS | current |
| DESCRIPTION | |

```
          “This object describes the event.”
      ::= { wmanIfSsEventEntry 2 }
wmanIfSsEventSeverity  OBJECT-TYPE
```

| | |
|---|---|
| SYNTAX | WmanIfEventSeverity |
| MAX-ACCESS | read-write |
| STATUS | current |
| DESCRIPTION | |

```
          “This object describes the severity of such event.
            The system will assign a severity for each event. But,
            it can be configurable by NMS”
      ::= { wmanIfSsEventEntry 3 }
wmanIfSsEventNotification  OBJECT-TYPE
```

| | |
|---|---|
| SYNTAX | TruthValue |
| MAX-ACCESS | read-write |
| STATUS | current |
| DESCRIPTION | |

```
          “An event notification will be reported when it is
            True (1).”
      DEFVAL  { 2 }
      ::= { wmanIfSsEventEntry 4 }
wmanIfSsEventNotificationOid OBJECT-TYPE
```

| | |
|---|---|
| SYNTAX | OBJECT IDENTIFIER |
| MAX-ACCESS | read-only |
| STATUS | current |
| DESCRIPTION | |

```
“This is the object identifier of a NOTIFICATION-TYPE
            object. If wmanIfSsEventNotification is True, a trap that
            is identified by this OID will be reported.”
      DEFVAL  { wmanSsEventTrap }
      ::= { wmanIfSsEventEntry 5 }
wmanIfSsEventLogTable OBJECT-TYPE
```

| | |
|---|---|
| SYNTAX | SEQUENCE OF WmanIfSsEventLogEntry |
| MAX-ACCESS | not-accessible |
| STATUS | current |
| DESCRIPTION | |

```
          “This is the Syslog table that is used to store SS local
            events. This table should reside in the non-volatile
            memory that should presist after power cycle or reboot.
            The number of entries in this table is determined by
            wmanIfSsEventLogEntryLimit. It is a wrap around buffer.
            When the buffer is full, the oldest entry will be removed
            to make room for the newest entry.”
      ::= { wmanIfSsEventLog 7 }
wmanIfSsEventLogEntry OBJECT-TYPE
```

| | |
|---|---|
| SYNTAX | WmanIfSsEventLogEntry |
| MAX-ACCESS | not-accessible |
| STATUS | current |
| DESCRIPTION | |

```
          “Entries appear in this table when events occur, and are
            removed to make ways for new entries when buffer is full,
            the entry passes the lifetime limit. This table is
            indexed by ifIndex and wmanIfSsEventLogIndex.”
      INDEX  { ifIndex, wmanIfSsEventLogIndex }
      ::= { wmanIfSsEventLogTable 1 }
WmanIfSsEventLogEntry ::= SEQUENCE {
```

| | |
|---|---|
| wmanIfSsEventLogIndex | Unsigned32, |
| wmanIfSsEventId | INTEGER, |
| wmanIfSsEventLoggedTime | TimeStamp, |
| wmanIfSsEventLogDescription | SnmpAdminString, |
| wmanIfSsEventLogSeverity | WmanIfEventSeverity} |

wmanIfSsEventLogIndex OBJECT-TYPE

| | |
|---|---|
| SYNTAX | Unsigned32 (1..4294967295) |
| MAX-ACCESS | read-only |
| STATUS | current |
| DESCRIPTION | |

```
          “A monotonically increasing integer for the sole purpose
            of indexing entries within the event log. When it
            reaches the maximum value, the agent wraps the value
            back to 1.”
      ::= { wmanIfSsEventLogEntry 1 }
wmanIfSsEventId OBJECT-TYPE
```

| | |
|---|---|
| SYNTAX | INTEGER |
| MAX-ACCESS | read-only |
| STATUS | current |
| DESCRIPTION | |

```
          “The identifier of a SS event.”
      ::= { wmanIfSsEventLogEntry 2 }
wmanIfSsEventLoggedTime OBJECT-TYPE
```

| | |
|---|---|
| SYNTAX | TimeStamp |
| MAX-ACCESS | read-only |
| STATUS | current |
| DESCRIPTION | |

```
          “The value of sysUpTime when the entry was placed in the
            log. If the entry occurred before the most recent
            management system initialization this object value must
            be set to zero.”
      ::= { wmanIfSsEventLogEntry 3 }
wmanIfSsEventLogDescription OBJECT-TYPE
```

| | |
|---|---|
| SYNTAX | SnmpAdminString |
| MAX-ACCESS | read-only |
| STATUS | current |
| DESCRIPTION | |

```
          “This object describes the event.”
      ::= { wmanIfSsEventLogEntry 4 }
wmanIfSsEventLogSeverity  OBJECT-TYPE
```

| | |
|---|---|
| SYNTAX | WmanIfEventSeverity |
| MAX-ACCESS | read-only |
| STATUS | current |
| DESCRIPTION | |

```
        “This object describes the severity of such event.”
      ::= { wmanIfSsEventLogEntry 5 }
wmanSsEventTrap NOTIFICATION-TYPE
```

| | |
|---|---|
| OBJECTS | {wmanIfSsEventId, |
| | wmanIfSsEventLogIndex, |
| | wmanIfSsEventLoggedTime, |
| | wmanIfssEventDescription, |
| | wmanIfSsEventSeverity} |

| | |
|---|---|
| STATUS | current |
| DESCRIPTION | |

```
          “This trap report the event.”
      ::= { wmanIfSsTrapDefinitions 5 }
```

1. An apparatus, comprising:
a managed node to store a managed object associated with an event and to provide the managed object to a network management system, the managed object comprising:
an event table to store an event table entry defining an event at the managed node, the event table entry comprising an event severity attribute; and
an event log table to store an event log table entry when the event severity attribute is greater than or equal to a severity threshold.

2. The apparatus of claim 1, wherein the event severity attribute comprises one or more of: an emergency event, an alert event, a critical event, an error event, a warning event, a notice event, an informational event, and a debug event.

3. The apparatus of claim 1, wherein the severity threshold is configurable by the network management system.

4. The apparatus of claim 1, wherein events are created dynamically to meet needs of service providers.

5. The apparatus of claim 1, wherein the event table entry further comprises an event notification attribute that determines whether the managed node should or should not report the event to the network management system.

6. The apparatus of claim 5, wherein the event notification attribute is configurable by the network management system.

7. The apparatus of claim 1, further comprising a Buffer wrap-around enabled attribute configurable by the network management system to enable and disable log buffer wrap-around.

8. The apparatus of claim 7, wherein the log buffer wrap-around can be disabled to prevent critical events from erasing newer events.

9. The apparatus of claim 1, wherein aging events that pass an event life time can be deleted from a log buffer.

10. The apparatus of claim 9, wherein the event life time is configurable by the network management system.

11. A system, comprising:
an antenna; and
a managed node to couple to said antenna, said managed node to store a managed object associated with an event and to provide the managed object to a network management system, the managed object comprising:
an event table to store an event table entry defining an event at the managed node, the event table entry comprising an event severity attribute; and
an event log table to store an event log table entry when the event severity attribute is greater than or equal to a severity threshold.

12. The system of claim 11, wherein the event severity attribute comprises one or more of: an emergency event, an alert event, a critical event, an error event, a warning event, a notice event, an informational event, and a debug event.

13. The system of claim 11, wherein the severity threshold is configurable by the network management system.

14. The system of claim 11, wherein the event table entry further comprises an event notification attribute, and the managed node reports the event to the network management system based on the event notification attribute.

15. The system of claim 14, wherein the event notification attribute is configurable by the network management system.

16. A method, comprising:
storing an event table entry in an event table, the event table entry defining an event at a managed node and comprising an event severity attribute; and
storing an event log table entry in an event log table when the event severity attribute is greater than or equal to a severity threshold.

17. The method of claim 16, wherein the event severity attribute comprises one or more of: an emergency event, an alert event, a critical event, an error event, a warning event, a notice event, an informational event, and a debug event.

18. The method of claim 16, wherein the severity threshold is configurable by a network management system.

19. The method of claim 16, further comprising reporting the event to a network management system based on an event notification attribute stored in the event table.

20. The method of claim 19, wherein the event notification attribute is configurable by the network management system.

21. An article comprising a machine-readable storage medium containing instructions that if executed enable a system to:
store an event table entry in an event table, the event table entry defining an event at a managed node and comprising an event severity attribute; and
store an event log table entry in an event log table when the event severity attribute is greater than or equal to a severity threshold.

22. The article of claim 21, wherein the event severity attribute comprises one or more of: an emergency event, an alert event, a critical event, an error event, a warning event, a notice event, an informational event, and a debug event.

23. The article of claim 21, wherein the severity threshold is configurable by a network management system.

24. The article of claim 21, further comprising instructions that if executed enable a system to report the event to a network management system based on an event notification attribute stored in the event table.

25. The article of claim 24, wherein the event notification attribute is configurable by the network management system.
